(19) United States
(12) Patent Application Publication
(10) Pub. No.: US 2018/0029443 A1
(43) Pub. Date: Feb. 1, 2018

(54) SYSTEM FOR MULTI-ZONE VEHICLE HEATING

(71) Applicant: Ford Global Technologies, LLC, Dearborn, MI (US)

(72) Inventors: Angel Fernando Porras, Dearborn, MI (US); Timothy Noah Blatchley, Dearborn, MI (US)

(73) Assignee: Ford Global Technologies, LLC

(21) Appl. No.: 15/219,363

(22) Filed: Jul. 26, 2016

(51) Int. Cl. B60H 1/00; B60H 1/03

(52) U.S. Cl. CPC B60H 1/00885; B60H 1/03; B60H 2001/00942

(57) ABSTRACT

A vehicle heating system is disclosed. The system comprises an engine configured to heat a coolant and an electric heater configured to heat the coolant. A coolant supply valve is configured to selectively direct the coolant to the engine. The system further comprises a plurality of heat exchangers configured to receive the coolant and at least one heat exchanger control valve. The at least one heat exchanger control valve is configured to selectively allow the coolant to flow to one of the heat exchangers.

### FIELD OF THE INVENTION

The present disclosure generally relates to vehicle heating systems, and more particularly, to vehicle heating systems for multi-zone heating control.

### BACKGROUND OF THE INVENTION

Conventional vehicles use waste heat from a combustion engine as the sole source of heating for the passenger compartment. However, Battery Electric Vehicles (HEV) may have intermittent access to waste heat such that they may require additional heat sources. Plug-in Hybrid Electric Vehicles (PHEV) may further compound this issue by running with the combustion engine off for significant periods of time. The disclosure provides for systems and methods to heat the passenger compartment without relying solely on engine waste heat.

### SUMMARY OF THE INVENTION

According to one aspect of the present disclosure, a vehicle heating system is disclosed. The heating system comprises an engine configured to heat a coolant and an electric heater configured to heat the coolant. A coolant supply valve is configured to selectively direct the coolant to the engine and a plurality of heat exchangers are configured to receive the coolant. The system further comprises at least one heat exchanger control valve configured to selectively allow the coolant to flow to one of the heat exchangers.

According to another aspect of the present disclosure, a hybrid vehicle heating system is disclosed. The system comprises an engine configured to heat a coolant and an electric heater configured to heat the coolant. A coolant supply valve is configured to selectively circulate the coolant through the engine in response to a temperature of the coolant in the engine. The system further comprises a plurality of heater cores configured to receive the coolant and at least one heater control valve configured to direct the coolant to one of the heat cores.

According to yet another aspect of the present disclosure, a vehicle heating system is disclosed. The system comprises an engine configured to heat a coolant and an electric heater configured to heat the coolant. The system further comprises a plurality of heat exchangers are configured to receive the coolant and a controller in communication with the electric heater and the engine. The controller is configured to control a coolant supply valve configured to selectively direct the coolant to the engine and control at least one heat exchanger control valve to selectively allow the coolant to flow to one of the heat exchangers.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a schematic representation of a hybrid vehicle;

FIG. 2 is a schematic view of a vehicle heating system for multi-zone heating;

FIG. 3 is a schematic view of a vehicle heating system for multi-zone heating demonstrating a plurality of heating loops;

FIG. 4A is a process diagram demonstrating a method for controlling a heating process for a vehicle;

FIG. 4B is a flow chart demonstrating a subroutine for the heating process of FIG. 4A for controlling a Heater Core Isolation Valve (HCIV);

FIG. 4C is a flow chart demonstrating a subroutine for the heating process of FIG. 4A for controlling an engine temperature subroutine; and

FIG. 5 is a process diagram demonstrating a method for controlling an electric heating process for a vehicle in accordance with the disclosure.

### DETAILED DESCRIPTION OF THE PREFERRED EMBODIMENTS

As required, detailed embodiments of the present disclosure are disclosed herein. However, it is to be understood that the disclosed embodiments are merely exemplary of the disclosure that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present disclosure.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a heating system that may be utilized in a hybrid vehicle. The heating system may provide for improved passenger comfort while maintaining a high level of operating efficiency for the vehicle. In some embodiments, the system may provide for a multi-zone heating system that may selectively generate heat from an electric heater or utilize waste heat from a combustion engine to heat a passenger compartment. An exemplary application of the system may be in the form of full size passenger vehicles (e.g. sport utility vehicles (SUVs, vans, full size cars, etc) that may be equipped with hybrid drive systems.

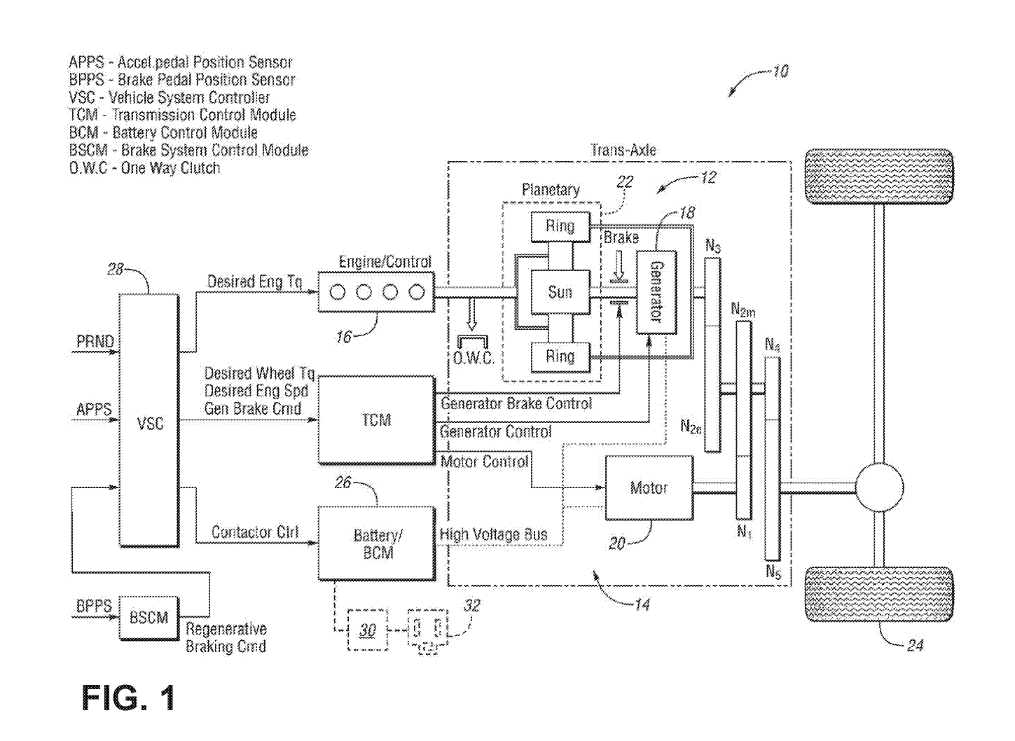

FIG. 1 illustrates a hybrid electric vehicle (HEV) 10 powertrain configuration and control system. A power split hybrid electric vehicle 10 may be a parallel hybrid electric vehicle. The HEV configuration as shown is for purposes of example only and is not intended to be limiting as the present disclosure applies to HEVs, PHEVs, or other vehicle types of any suitable architecture. As demonstrated in FIG. 1, the powertrain configuration may comprise two power sources 12, 14 that are connected to the driveline. The power sources may include a combination combustion engine generator subsystem and an electric drive system. The engine and generator may comprise a planetary gear set connecting the generator to the engine. The electric drive system may comprise an electric motor subsystem, a generator subsystem, and a battery subsystem. The battery subsystem may correspond to an energy storage system for the generator and the motor.

The speed of the charging of the generator 18 may vary based on the engine output power split between an electrical path and a mechanical path. In a vehicle 10 with a power split powertrain system, the engine 16 may require either the generator torque resulting from engine speed control or the generator brake torque to transmit its output power through both the electrical and mechanical paths (split modes) or through the all-mechanical path (parallel mode) to the drivetrain for forward motion. During operation using the second power source 14, the electric motor 20 may draw power from the battery 26 and provide propulsion independently of the engine 16 for forward and reverse motions. This operating mode may be called “electric drive,” electric-only mode, or EV mode.

The operation of the power split powertrain system, unlike conventional powertrain systems, may integrate the two power sources 12, 14 to work together seamlessly to meet the driver's demand without exceeding the system's limits (such as battery limits). Additionally, the demand may be met while optimizing the total powertrain system efficiency and performance. In order to function in this way, coordination control between the two power sources 12, 14 is needed. As shown in FIG. 1, there is a hierarchical vehicle system controller (VSC) 28 that may perform the coordination control for the power split powertrain system. Under normal powertrain conditions (no subsystems/components faulted), the VSC 28 may interpret the driver's demands (e.g. PRND and acceleration or deceleration demand). Based on the driver's demands and powertrain limits, the VSC 28 may then determine a wheel torque command. The VSC 28 may also determine the torque each power source needs to provide in order to meet the driver's torque demand and to achieve an operating point (torque and speed) of the engine.

In some embodiments, the battery 26 may be implemented in a rechargeable configuration (shown in phantom). The rechargeable configuration may utilize a receptacle 32 which may be connected to a power grid or other outside electrical power source. In this way, the battery 26 may be charged by the outside electrical power source via a battery charger/converter 30.

As described herein, the vehicle 10 may be operated in an electric mode (EV mode). In the EV mode, the battery 26 may provide all of the power to the electric motor 20 to operate the vehicle 10. In addition to the benefit of saving fuel, operation in EV mode may enhance the ride comfort through lower noise and better driveability. For example, some driveability characteristics may include smoother electric operation, lower noise, vibration, and harshness (NVH), and faster response. Operation in EV mode may also provide environmental benefits by limiting emissions and improving fuel economy.

A Plug-in Hybrid Electric Vehicle (PHEV) may share characteristics of both an internal combustion engine and a battery electric vehicle. For example, a PHEV may have a driving range in which propulsion is provided only by an electric motor 20 powered from a battery pack 26. Once the battery pack 26 charge has been depleted to a predetermined level, the engine 16 may be started. The engine 16 may provide power to propel the vehicle and to recharge the battery pack 26. In electric only mode, the engine 16 may be inactive. Since the engine 16 is inactive, heat may not be generated and consequently, engine heat may not be utilized to heat the passenger compartment. A PHEV may start the engine 16 in response to a need for passenger heating. This, however, may interfere with the electric only operation and may impact fuel economy and emissions.

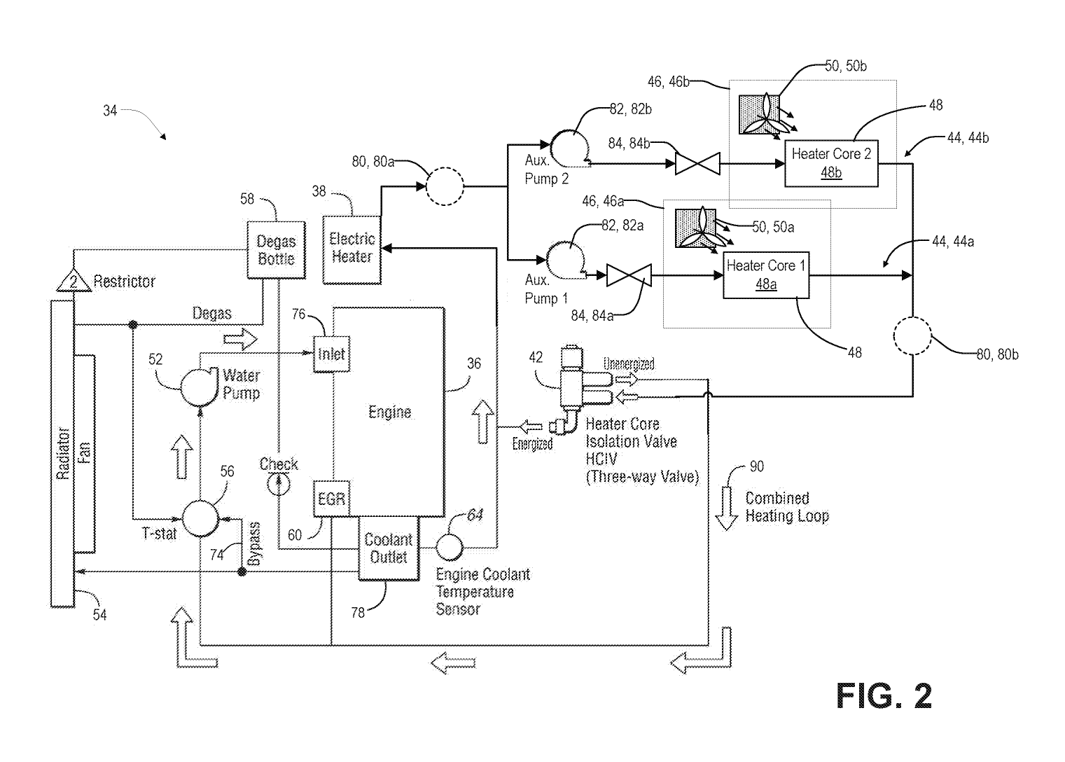

Referring now to FIG. 2, a heating system 34 for providing heat to a passenger compartment for a PHEV is shown. The system 34 may provide two sources to heat coolant for heating the vehicle 10. For example, as discussed in reference to FIG. 1, the vehicle system controller (VSC) 28 may utilize heat from the engine 36 to heat the coolant as in a conventional ICE vehicle. Additionally, when the heat from the engine 36 is insufficient, the VSC 28 may provide heat via an electric heater 38. The electric heater 38 may be similar to that utilized in a battery electric vehicle system and may correspond to a high voltage electric heater. Having multiple sources of heat may provide for flexibility during normal operating conditions and some redundancy during fault mode operation.

The system 34 may allow the coolant from either the engine 36 or the electric heater 38 to flow through at least one heater core 48. The at least one heater core 48 may correspond to a heat exchanger configured to deliver heated air to a passenger compartment of the vehicle 10. A Heater Core Isolation Valve (HCIV) 42 may provide for the VSC 28 to select the source of heated coolant to be the engine 36 or the electric heater 38. Though discussed in reference to the VSC 28, various controllers, circuits, and/or processors may communicate to control the various tasks described herein. Accordingly, the primary control described in reference to the various control methods and systems discussed herein is the VSC 28. However, it may be understood that various control circuits may be in communication with the VSC 28 to provide for the various controls and functions discussed herein.

The VSC 28, discussed in reference to FIG. 1, may determine the heating mode based on the passenger-heating request and the status of the various components in the heating system. Based on the passenger heating request, a desired coolant temperature of the heater core 40 is generated by or provided to the VSC 28 (FIG. 1). In operation, the goal of the heating system 34 may be to maintain the temperature of the heater core 40 at the desired temperature in the most fuel efficient manner possible. In this way, the system 34 may optimize operation such that efficiency is maintained without sacrificing the comfort of the passengers of the vehicle 10.

The electric heater 38 may be a positive temperature coefficient (PTC) type heater. PTC heating elements may be constructed with small ceramic stones that have self-limiting temperature properties. These properties may include a fast heating response time and the ability to automatically vary wattage to maintain a pre-defined temperature. As such, PTC heaters may be a selected for providing controlled electrical heat to a vehicle cabin. Though a PTC heater is discussed specifically in reference to the electric heater 38, various types of heaters may be incorporated into the system 34 without departing from the spirit of the disclosure.

The system 34 may further comprise at least one auxiliary water pump 43. The at least one auxiliary water pump 43 may be configured to force coolant to flow through the heating system 34, which may comprise a plurality of coolant paths or heating loops 44. The heating loops may correspond to a plurality of climate zones 46, which may provide for independent climate control for various regions of the vehicle. Additionally, one or more temperature sensors 46 may be in connection with the heating loops to identify a coolant temperature at one or more stages of the heating loops. In general, during operation the coolant flows through at least one heater core 48 that allows heat to be transferred from the coolant to air entering the passenger compartment. The heat may be transferred from the coolant and may flow into the at least one heater core 48 using a blower 50 to pass air over the heater core 48 and into the passenger compartment.

The system 34 may further comprise a water pump 52 configured to force fluid to flow through the engine 36. The water pump 52 may be electrically or mechanically driven. In certain modes, the water pump 52 may force fluid through the heating system 34 components as well. The system 34 may further comprise a radiator 54 configured to dissipate heat in the coolant. A flow path of the coolant may be controlled by the heating system 34 in response to an input from a thermostat 56. In this way, the heating system may control the flow of coolant between the radiator 54 and the engine 36 based on a temperature of the coolant identified by the thermostat 56.

In some embodiments, the system 34 may comprise a degas bottle 58 which may act as a coolant reservoir. Additionally, the degas bottle 58 may remove air from the coolant, and provide pressure relief. The cooling system may further include an exhaust gas recirculation (EGR) system 60 that recirculates a portion of the engine's exhaust gas back to the engine cylinders. Though specific components are discussed in reference to the heating system 34 for the vehicle 10, various components may be utilized to facilitate various functions of the heating system 34 as discussed herein. Accordingly, the system 34 may be tailored to suit various applications without departing from the spirit of the disclosure.

During operation, the VSC 28 may control the flow and temperature of the coolant based on a desired climate. The desired climate may be input by a passenger of the vehicle 10 via a user interface. In an exemplary embodiment, the user interface may be configured to receive the desired temperature for a plurality of climate zones 46 in the vehicle 10. For example, the climate zones 46 may correspond to a fore portion and an aft portion of the passenger compartment. The fore portion may correspond to a front seat region while the aft portion may correspond to a rear seat region. Accordingly, each of the climate zones 46 may correspond to front climate region and one or more additional climate regions of the vehicle. In some embodiments, the climate zones 46 may correspond to a driver-side and passenger side, a storage region and passenger compartment, etc.

Each of the climate zones 46 may be configured to receive heat from the one or more heating loops 44. For example, the VSC 28 may control the flow of the coolant to each of a first heating loop 44a and a second heating loop 44b. In this configuration, the VSC 28 may control the climate of each of a first zone 46a and a second zone 46b by controlling the flow of the coolant to each of the heating loops 44. In addition to controlling the flow of the coolant to each of the heating zones 46, the VSC 28 may further control the HCIV 42 to control the source of heated coolant from the engine 36 and/or the electric heater 38.

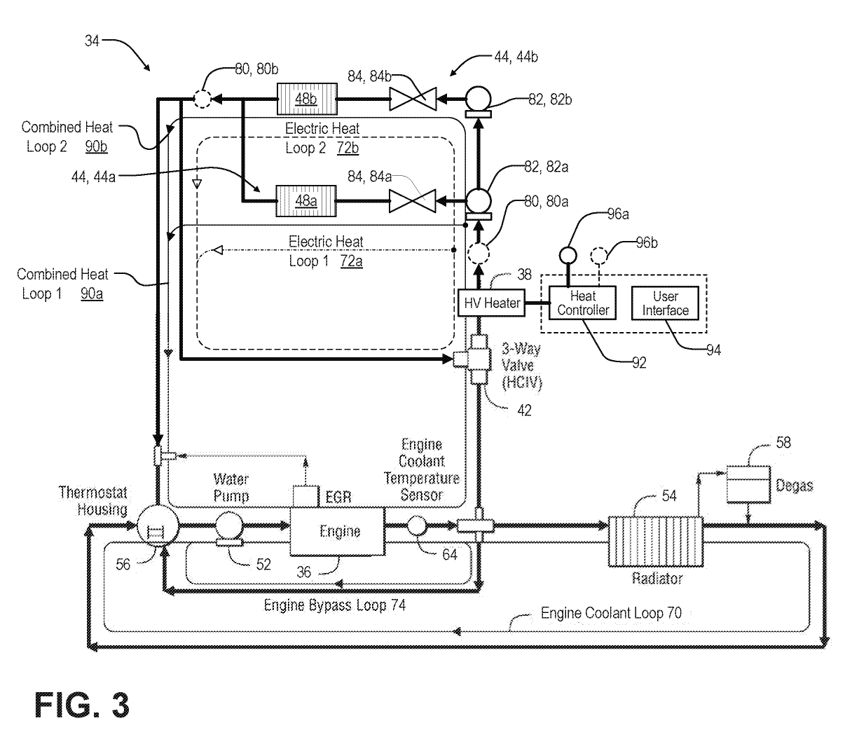

As discussed in reference to FIG. 1, during different periods of operation of the vehicle 10, the VSC 28 may identify whether the engine coolant is sufficiently warm to supply heated coolant to one or more of the first heater core 48a and a second heater core 48b. The VSC 28 may identify an engine coolant temperature (ECT) via an ECT sensor 64 configured to monitor the ECT in an engine coolant loop 70 for the engine 36. The engine coolant loop 70 is demonstrated in FIG. 3 and corresponds to a coolant circulation path of the coolant formed when the HCIV 42 is closed. Accordingly, the VSC 28 may be configured to control the HCIV 42 to isolate an electric heating loop 72 from the engine coolant loop 70. In this way, the system 34 may selectively supply heated coolant to the heater cores 48 from the electric heater 38 independent of the engine 36 and the corresponding engine coolant.

The engine coolant loop 70 may pass through the engine 36 via an inlet 76 and be released via an outlet 78. The outlet 78 may be in fluid communication with a Bypass and the radiator 54. In this configuration, the thermostat 56 may control whether the coolant flows through the radiator 54 to disburse heat or bypasses the radiator 54 to maintain/build heat. The thermostat 56 is in fluid communication with the water pump 52, which may return the coolant to the inlet 76. In this configuration, the water pump 52 may also supply the coolant to one or more of the heat cores in response to the engine temperature being greater than a temperature of the coolant output from the heater cores 48.

The electric heat loop 72 may be selectively isolated from the engine coolant loop 70 via the HCIV 42. In the closed configuration, the coolant may pass from the HCIV 42 to the electric heater 38. From the electric heater 38, the coolant may pass through at least one electric loop temperature gauge 80. The at least one electric loop temperature gauge 80 may correspond to a first electric loop temperature gauge 80a that may be positioned upstream of the heater cores 48. The coolant may be drawn from the electric heater 38 through at least one auxiliary pump 82 and at least one zone control valve 84 to selectively supply heated coolant to the first heater core 48a and/or the second heater core 48b. Accordingly, the zone control valves 84 may correspond to heat exchanger coolant supply valves for the heater cores 48. Following the heater cores 48, the coolant may pass through a second electric loop temperature gauge 80b and return to the HCIV 42. In this configuration, the VSC may control the auxiliary pumps 82 and the zone control valves 84 to supply heated coolant to each of the heat cores 48 to independently heat the zones 46.

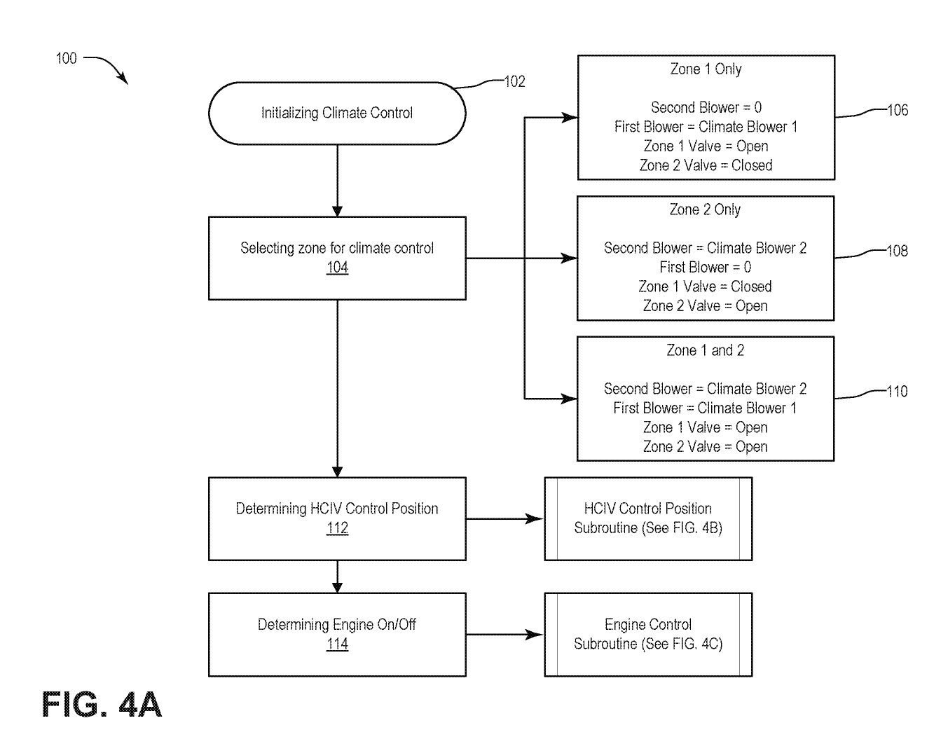

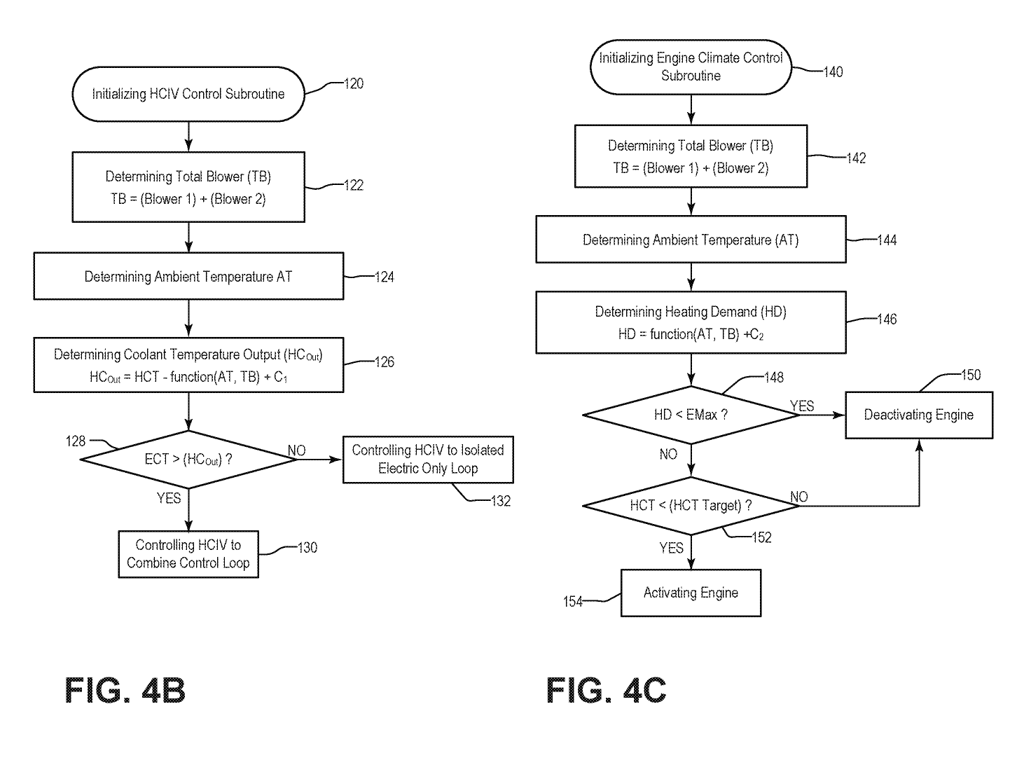

The VSC 28 may control the electric heater 38 to heat the coolant in response to a mode of operation of the system 34. The various modes of operation are discussed further in reference to FIG. 3. The VSC 28 may activate the electric heater in response to a temperature of the coolant. The temperature of the coolant during electric only operation of the vehicle 10 may be measured and communicated to the VSC 28 as it passes through at least one of the first electric loop temperature gauge 80a and/or the second electric loop temperature gauge 80b. Such a coolant temperature may be referred to as a heater coolant temperature (HCT), which is further discussed in reference to FIG. 4. In this configuration, the VSC 28 may control the system 34 to supply heat to each of the zones 46 during periods of electric only operation.

Referring now to FIGS. 2 and 3, the VSC 28 may control the HCIV 42 to selectively combine the engine coolant loop 70 with the electric heat loop 72 to supply heated coolant to the heater cores 48 via a combined coolant loop 90. The combined coolant loop 90 may typically be activated by the VSC 28 when the engine coolant temperature is sufficient to satisfy a demand for heat from the first heater core 48a and the second heater core 48b. The VSC 28 may identify the coolant temperature via the ECT sensor 64 and compare it to a heater core output requirement to identify whether to activate the electric heat loop 72 or the combined heat loop 90. Accordingly, the VSC 28 may selectively utilize heat generated by the engine 36 or utilize heat generated by the electric heater 38 to heat the heater cores 48.

Additionally, the VSC 28 may selectively control the flow of the coolant to each of the heater cores 48 based on a heating demand of an occupant of the vehicle 10. For example, the VSC 28 may be in communication with one or more heating zone valves 84 and configured to control the heating zone valves 84 to selectively supply the coolant to the first heater core 48a and/or the second heater core 48b. The VSC 28 may control the first heat zone valve 84a to activate heated coolant to be supplied to the first heater core 48a via a first heating zone loop 44a. Accordingly, the VSC 28 may be operable to selectively activate the first heating zone 46a in response to a passenger request via the user interface. When the first heat zone valve 84a is active, the VSC 28 may further control a first blower 50a such that heated air is delivered to the first zone 46a in the passenger compartment of the vehicle 10. In this way, the VSC 28 may supply coolant heated by either the engine 36 and/or the electric heater 38 to the first heater core 48a to heat the first zone 46a.

The VSC 28 may further be configured to control the second heat zone valve 84b to activate heated coolant to be supplied to the second heater core 48b via a second heating zone loop 44b. The VSC 28 may be operable to selectively activate the second heating zone 46b in response to a passenger request via the user interface. When the second heat zone valve 84b is active, the VSC 28 may further control a second blower 50b such that heated air is delivered to the second zone 46b in the passenger compartment of the vehicle 10. In this way, the VSC 28 may supply coolant heated by either the engine 36 and/or the electric heater 38 to the second heater core 48b to heat the second zone 46b.

The electric heat loops 72 and the combined heat loops 90 of the system 34 may correspond to coolant flow paths that deliver the coolant to one of the heater cores 48. A first combined heat loop 90a may be formed by the following path: coolant flowing from the engine 36 to the HCIV 42, from the HCIV 42 into the first heater core 48a via a first auxiliary pump 82a and the first heat zone valve 84a, and from the first heater core 48a back to the engine 36 via the thermostat 56. A second combined heat loop 90b may be formed by the following path: coolant flowing from the engine 36 to the HCIV 42, from the HCIV 42 into the second heater core 48b via a second auxiliary pump 82b and the second heat zone valve 84b, and from the second heater core 48b back to the engine 36 via the thermostat 56. Accordingly, the heating system 34 may comprise a plurality of combined heating loops 90 that may be selectively activated by the VSC 28 when the engine 36 is operating.

Additionally, when the engine 36 is not operating, the VSC 28 may heat the zones 46 of the passenger compartment with the electrical heat loops 72. A first electric heat loop 72a may be formed by the following path: coolant drawn from the HCIV 42 through the first heat zone valve 84a in the open position via the first auxiliary pump 82a, into the first heater core 48a from the first heat zone valve 84a, and back to the HCIV 42 from the first heater core 48a. A second electric heat loop 72b may be formed by the following path: coolant drawn from the HCIV 42 through the second heat zone valve 84b in the open position via the second auxiliary pump 82b, into the second heater core 48b from the second heat zone valve 84b, and back to the HCIV 42 from the second heater core 48b. Accordingly, the heat system 34 may provide for a plurality of combined heat loops 90 for operation when the engine is discharging heat and a plurality of electric heat loops 72 for operation when the engine 36 is not discharging sufficient heat to heat the coolant.

In some embodiments, the system 34 may comprise additional controllers that may be configured to control one or more of the processes described herein. For example, in some embodiments, the electric heater 38 may correspond to a high voltage heater. The electric heater 38 may be controlled by a heat controller 92, which may be in communication with a user interface 94. In this configuration, the heat controller 92 may be in communication with the VSC 28 and configured to control and communicate a heating instruction received from a passenger of the vehicle 10 via the user interface 94.

The system 34 may further comprise at least one ambient air temperature gauge 96. The ambient air temperature gauge may be in communication with at least one of the controller 92 and the VSC 28. The ambient air temperature gauge 96 may be configured to identify an air temperature of air passing over the heater cores 48 via the blowers 50. In some applications, the system 34 may comprise a first ambient air temperature gauge 96a configured to measure the air temperature of air entering the first blower 50a and a second ambient air temperature gauge 96b configured to measure the air temperature of air entering the second blower 50b. Accordingly, the system may be operable to determine the temperature of ambient air supplied to the heater cores 48 to estimate a heat load or heat demand of the coolant.

Referring now to FIGS. 4A, 4B, and 4C, various diagrams demonstrating an exemplary operating method 100 for the system 34 are shown. Beginning in reference to FIG. 4A, the climate control or heating of the vehicle 10 may be initialized in response to a vehicle startup sequence or the receipt of a climate adjustment to a user interface of the vehicle 10 (102). In response to the initializing of the climate control, the VSC 28 may select the zone(s) 46 for climate control of the vehicle 10. The VSC 28 may select the zone(s) 46 in response to a heat setting, which may be selected by a passenger of the vehicle 10 via the user interface (104). Based on the heat setting requested, the VSC 28 may continue to control each of the blowers 50 and the valves 84 to selectively output the heat to the zones 46 of the vehicle 10.

In response to a request for heat to the first zone 46a, the VSC 28 may control the heating system 34 as follows: activate the first blower 50a to a level commensurate to the requested heat, deactivate or maintain an idle state of the second blower 50b, open the first heat zone valve 84a, and close the second heat zone valve 84b (106). In response to a request for heat to the second zone 46b, the VSC 28 may control the heating system 34 as follows: activate the second blower 50b to a level commensurate to the requested heat, deactivate or maintain an idle state of the first blower 50a, close the first heat zone valve 84a, and open the second heat zone valve 84b (108). In response to a request for heat to the first zone 46a and the second zone 46b, the VSC 28 may control the heating system 34 as follows: activate the first blower 50a to a level commensurate to the requested heat, activate the second blower 50b to a level commensurate to the requested heat, open the first heat zone valve 84a, and open the second heat zone valve 84b (110).

As discussed in reference to FIGS. 2 and 3, the VSC 28 of the system 34 may also control the HCIV 42 and the engine 36 to ensure that the temperature of the coolant supply for the heater core(s) 48 if sufficient to provide heated coolant to suit the operating demand. Accordingly, the VSC 28 may determine the HCIV control position by activating a Control Position Subroutine for the HCIV 42 (112). The HCIV control subroutine is discussed further in reference to FIG. 4B. Additionally, the system 34 may selectively activate the engine 36 to supply heated coolant to the heater cores 48. An engine control subroutine may be activated by the VSC 28 to determine an engine on/off condition (114). The engine control subroutine is further discussed in reference to FIG. 4C.

Referring now to FIG. 4B, the HCIV control subroutine 120 may be initialized by the VSC 28 in response to a heating request to supply heat to one or more of the climate zones 46 of the vehicle 10. The HCIV control subroutine 120 may be configured to identify whether the engine coolant temperature measured by the ECT sensor 64 is sufficient to heat the coolant to supply heat to the heater cores 48. As discussed previously, during some periods of operation, the engine 36 may be idle. Accordingly, the HCIV 42 may isolate the electric heat loops 72 to prevent cooling of the coolant by the engine 36.

Once initialized, the VSC 28 may apply the HCIV control subroutine 120 to identify a total blower demand (TB) of the system 34. The total blower demand (TB) may be calculated as a total blower cooling rate of the first blower 50a and the second blower 50b (122). The blower flow rate of each of the blowers 50 may be approximated as a scalar value corresponding to a blower setting of the blowers 50 and summed. For example, the scalar value may correspond to a control value for each of the blowers 50 that may range from 0 to 10 or low to high with some intermediate level of precision ranging therebetween. Such a blower setting may be set by the system 34 based on a temperature differential between an ambient temperature AT of each climate zone 46 compared to a user temperature setting for each of the respective climate zones.

The control subroutine may continue to determine the ambient temperature of the passenger compartment or each of the zones 46 of the vehicle 10. The ambient temperature AT may be identified by the VSC 28 in step 124 based a temperature signal from at least one temperature gauge 96 in the passenger compartment of the vehicle 10. Accordingly, the VSC 28 may be operable to determine the total blower demand TB and the ambient temperature AT to infer or calculate a coolant output temperature (HC_{Out}) of the coolant output from the heater cores 48 in step 126.

The coolant output temperature (HC_{Out}) may be determined as the difference between the heater coolant temperature (HCT) and the heat demand of the heater cores 48 of each of the climate zones 46. The heater coolant temperature (HCT) may be identified by the VSC 28 as a temperature signal from the first electric loop temperature gauge 80a. Equation 1 demonstrates the equation for the coolant output temperature (HC_{Out}) as the difference between the heater coolant temperature (HCT) and the heat demand of the climate zones.

HC_{Out}=HCT−funct(AT, TB) (eq. 1)

Accordingly, based on equation 1, the VSC 28 may calculate the coolant output temperature (HC_{Out}) as the difference between the heater coolant temperature (HCT) and a function of the ambient temperature and the total blower demand TB. Based on the coolant output temperature (HC_{Out}), the system 34 may control an instruction of the HCIV 42.

In some embodiments, the VSC 28 may comprise the second electric loop temperature gauge 80b. In such systems, the VSC 28 may measure the coolant output temperature (HC_{Out}) from a second coolant temperature of the second electric loop temperature gauge 80b. As previously discussed in reference to FIGS. 2 and 3, the heater coolant temperature HCT may be measured and communicated to the VSC 28 as it passes through the first electric loop temperature gauge 80a and/or the second electric loop temperature gauge 80b. Accordingly, the HCIV control subroutine may provide for a flexible control solution for various vehicles.

With the coolant output temperature (HC_{Out}) calculated, the VSC 28 may compare the coolant output temperature (HC_{Out}) with the engine coolant temperature ECT (128). As discussed in reference to FIGS. 2 and 3, the engine coolant temperature ECT may be communicated to the VSC 28 from the ECT sensor 64. If the engine coolant temperature ECT is greater than the coolant output temperature (HC_{Out}), the VSC 28 may control the HCIV 42 to activate the heating loops 44 to supply heated coolant to the heater cores 48 (130). If the engine coolant temperature ECT is not greater than the coolant output temperature (HC_{Out}), the VSC 28 may control the HCIV 42 to activate the electric only heat loops 72 such that the electric heater 38 supplies heat to the heater cores 48 (132). Accordingly, the system 34 may provide for efficient operation by utilizing the heat of the engine 36 to supplement or supply heat for the system 34 when the engine coolant temperature is sufficient.

Referring now to FIG. 4C, the VSC 28 may be configured to activate the engine climate control subroutine 140 depending on a heat demand of the system 34. Depending on a heating demand HD of the heat cores 48 of the system 34, the VSC 28 may activate the engine 36 to supplement a heat supplied by the electric heater 38. In some embodiments, heat generated by the engine 36 may be necessary to heat the vehicle 10 if the heating demand (HD) of the heater cores 48 exceeds maximum electric heat supply threshold (EMax).

In step 142, the method may determine the total blower demand (TB) of the system 34. The total blower demand (TB) may be calculated as a total blower cooling rate of the first blower 50a and the second blower 50b (122). As discussed in reference to FIG. 4B, the blower flow rate of each of the blowers 50 may be approximated as a scalar value corresponding to a blower setting of the blowers 50 and summed. The engine climate control subroutine 140 may continue to determine the ambient temperature of the passenger compartment or each of the zones 46 of the vehicle 10 (144). The ambient temperature (AT) may be identified by the VSC 28 in step 144 based a temperature signal from at least one temperature gauge 96 in the passenger compartment of the vehicle 10. Accordingly, the VSC 28 may be operable to determine the total blower demand TB and the ambient temperature AT to estimate the heating demand (HD) of the system 34.

The heating demand (HD) is calculated as a function of the ambient temperature AT and the total blower demand (TB) (146). The heating demand (HD) may be similar to the heat demand of the heater cores 48 of each of the climate zones 46 applied in step 126. The functions may differ in steps 126 and 146 in that each function may be weighted differently or include a different constant to adjust operating behavior of the corresponding control schemes. Accordingly, based on the heating demand, the system 34 may selectively activate the engine 36 to assist the electric heater 38 in supplying heat to meet the heating demand (HD).

To determine if operation of the engine 36 is required to supply heat to meet the heating demand (HD), the subroutine 140 may compare the heating demand (HD) to the maximum electric heat supply threshold (EMax) (148). If HD is less than EMax, the engine 36 may be deactivated because the electric heater 38 has sufficient power to provide for the heating demand (HD) (150.) If HD is not less than EMax, the subroutine 140 may continue to step 152 to compare the heater coolant temperature (HCT) to a heater coolant temperature target (HCT Target). If HCT is greater than the HCT Target, the engine 36 may be deactivated because there is not yet a need for heat from the engine 36 to heat the coolant. If HCT is not greater than the HCT Target, the engine 36 may be activated by the system 34 to supply heat to the coolant to satisfy the heating demand (HD) (154).

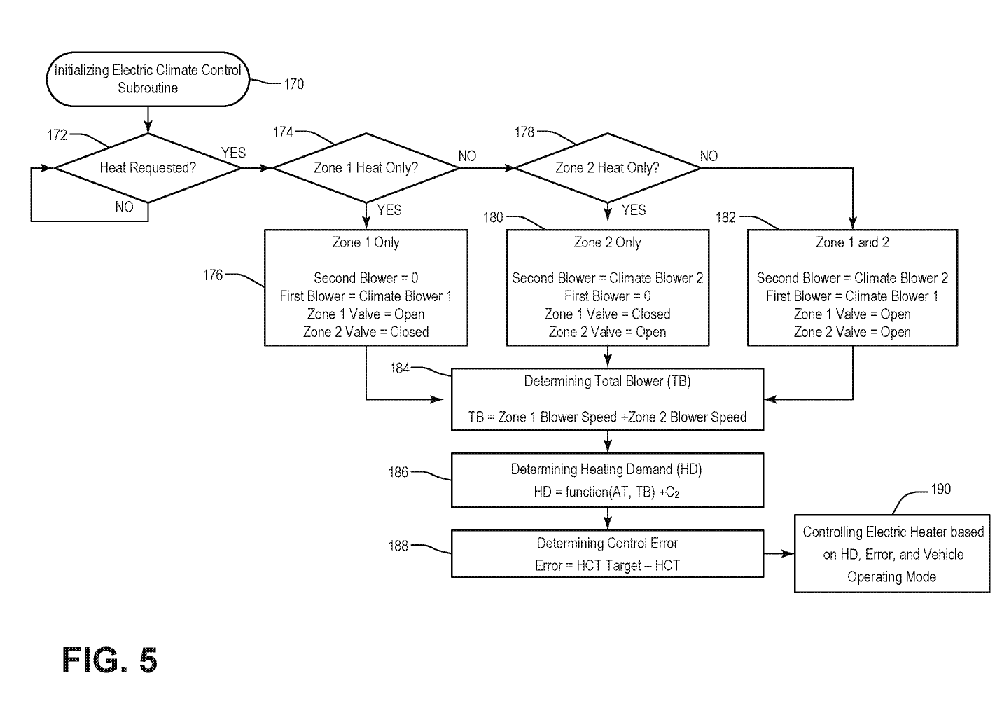

As discussed in reference to FIG. 4, exemplary embodiments of the system 34 were discussed in reference to the operation of the HCIV 42 and the engine 36 to supply heat to the heater cores 48. Referring now to FIG. 5, a control routine 170 for the electric heater 38 is discussed demonstrating a method for controlling the temperature of the plurality of climate zones 46 with the electric heater 38. The heat controller 92 discussed in reference to FIG. 3 may be configured to control the electric heater 38 and may further be communication with the VSC 28 to integrate the control of the various systems and methods described herein.

Once initialized, the control routine 170 may determine if heat is requested for the vehicle 10 (172). If heat is not request, the heat controller 92 may remain at step 172 until heat is requested. If heat is requested, the VSC 28 and the heat controller 92 may determine if the heat is requested in first zone 46a (174). In response to a request for heat to the first zone 46a, the heat controller 92 may control the heating system 34 as follows: activate the first blower 50a to a level commensurate to the requested heat, deactivate or maintain an idle state of the second blower 50b, open the first heat zone valve 84a, and close the second heat zone valve 84b (176). If heat is not requested in only the first zone 46a, the control routine 170 may determine if heat is requested in second zone 46b (178).

In response to a request for heat to the second zone 46b, the VSC 28 and the heat controller 92 may control the heating system 34 as follows: activate the second blower 50b to a level commensurate to the requested heat, deactivate or maintain an idle state of the first blower 50a, close the first heat zone valve 84a, and open the second heat zone valve 84b (180). If heat is not only requested in only one of the first zone 46a or the second zone 46b, the routine 170 may continue to heat the first zone 46a and the second zone 46b. In response to a request for heat to the first zone 46a and the second zone 46b, the VSC 28 and the heat controller 92 may control the heating system 34 as follows: activate the first blower 50a to a level commensurate to the requested heat, activate the second blower 50b to a level commensurate to the requested heat, open the first heat zone valve 84a, and open the second heat zone valve 84b (182).

After identifying the zones 46 that are operating, the control routine 170 may determine the total blower demand (TB) for the system 34. The total blower demand (TB) may be calculated as a total blower cooling rate of the first blower 50a and the second blower 50b (184). As discussed in reference to FIG. 4B, the blower flow rate of each of the blowers 50 may be approximated as a scalar value corresponding to a blower setting of the blowers 50 and summed. The engine climate control subroutine 140 may continue to determine the ambient temperature of the passenger compartment or each of the zones 46 of the vehicle 10. The ambient temperature (AT) may be identified by the heater controller 92 in step 144 based a temperature signal from at least one temperature gauge 96 in the passenger compartment of the vehicle 10.

Based on the total blower demand (TB) and the ambient temperature (AT), the heat controller 92 may determine the coolant output temperature (HC_{Out}). The coolant output temperature (HC_{Out}) may be determined as the difference between the heater coolant temperature (HCT) and the heat demand of the heater cores 48 of each of the climate zones 46. The heater coolant temperature (HCT) may be identified by the heat controller 92 and/or the VSC 28 as a temperature signal from the first electric loop temperature gauge 80a. Accordingly, based on equation 1, the VSC 28 may calculate the coolant output temperature (HC_{Out}) as the difference between the heater coolant temperature (HCT) and a function of the ambient temperature and the total blower demand TB.

The routine 170 may further identify a control error in the heater coolant temperature (HCT) (188). The control error may be calculated as the difference between a coolant temperature target (HCT Target) and the heater coolant temperature (HCT). In this way, the routine 170 may compare the response of the heater coolant temperature (HCT) to various settings and inputs into the electric heater 38. Based on the calculation of coolant output temperature (HC_{Out}) and the control error, the VSC 28 and the heat controller 92 may control an input to the electric heater 38 to ensure that the heater operates to accurately heat the passenger compartment of the vehicle 10 (190).

Additionally, the control routine for the electric heater 38 may identify an operating mode of the vehicle 10 (e.g. electric-only mode, combustion hybrid mode, etc.) to control the electric heater 38. For example, if the battery 26 is diminished, the VSC 28 may control the engine 36 to activate to assist in propulsion of the vehicle 10. Under such circumstances, the engine coolant temperature (ECT) would likely heat to a level such that it may be utilized to heat the coolant as a result of the engine coolant temperature (ECT) being greater than the coolant output temperature (HC_{Out}). Accordingly, the various routines and methods (e.g. 120, 140, 170, etc.) discussed herein may provide comprehensive operational instructions to controlling the system 34.

The system 34 may also incorporate a Cold Engine Lock Out (CELO) feature. A CELO feature may inhibit operation of the blowers 50 until the coolant has reached a certain threshold. The system 34 may request that the engine 36 be turned on to assist in heating the coolant. Once the coolant has achieved a certain threshold, the fan speed of the blower 50 may be increased to allow heated air to flow into the passenger compartment.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle heating system comprising:
an engine configured to heat a coolant;
an electric heater configured to heat the coolant;
a coolant supply valve configured to selectively direct the coolant to the engine;
a plurality of heat exchangers configured to receive the coolant; and
at least one heat exchanger control valve configured to selectively allow the coolant to flow to one of the heat exchangers.

2. The heating system according to claim 1, wherein the at least one heat exchanger control valve is configured to heat a plurality of climate zones utilizing heat dissipated by each of the heat exchangers.

3. The heating system according to claim 1, wherein the at least one heat exchanger control valve is further configured to allow the coolant to flow to one of the plurality of climate zones.

4. The heating system according to claim 1, further comprising an auxiliary pump configured to selectively pump the coolant to at least one of the plurality of heat exchangers.

5. The heating system according to claim 1, wherein the at least one heat exchanger control valve corresponds to a first heat exchanger control valve and a second heat exchanger control valve.

6. The heating system according to claim 5, wherein the first heat exchanger control valve is configured to selectively enable delivery of the coolant to a first climate zone and the second heat exchanger control valve is configured to selectively enable delivery of the coolant to a second climate zone.

7. The heating system according to claim 6, wherein the first climate zone corresponds to a forward seating portion of the vehicle and the second climate zone corresponds to a rear seating portion of the vehicle

8. A hybrid vehicle heating system comprising:
an engine configured to heat a coolant;
an electric heater configured to heat the coolant;
a coolant supply valve configured to selectively circulate the coolant through the engine in response to a temperature of the coolant in the engine;
a plurality of heater cores configured to receive the coolant; and
at least one heater control valve configured to direct the coolant to one of the heater cores.

9. The system according to claim 8, further comprising an engine coolant temperature sensor configured to identify the temperature of the coolant in the engine.

10. The system according to claim 8, wherein the at least one heater control valve is configured to direct the coolant to a climate zone of the vehicle.

11. The system according to claim 10, wherein the at least one heater control valve is configured to selectively direct the coolant to a selected heater core of the plurality of heater cores.

12. The system according to claim 8, wherein the plurality of heater cores correspond to a first heat exchanger configured to heat a first climate zone and a second heat exchanger configured to heat a second climate zone.

13. The system according to claim 12, further comprising at least one auxiliary pump configured to deliver the coolant to a selected heater core.

14. The system according to claim 13, wherein the at least one auxiliary pump corresponds to a first auxiliary pump configured to supply the coolant to the first heat exchanger and a second auxiliary pump configured to supply the coolant to the second heat exchanger.

15. A vehicle heating system comprising:
an engine configured to heat a coolant;
an electric heater configured to heat the coolant;
a plurality of heat exchangers configured to receive the coolant; and
a controller in communication with the electric heater and the engine and configured to:
control a coolant supply valve configured to selectively direct the coolant to the engine; and
control at least one heat exchanger control valve to selectively allow the coolant to flow to one of the heat exchangers.

16. The system according to claim 15, further comprising an engine coolant temperature sensor configured to measure an engine coolant temperature in communication with the controller.

17. The system according to claim 16, further comprising a plurality of blowers configured to transfer heat from the heat exchangers to a passenger compartment of the vehicle.

18. The system according to claim 17, further comprising an electric coolant temperature sensor configured to identify a heat exchanger input coolant temperature.

19. The system according to claim 17, wherein the controller is further configured to:
determine heat exchanger output temperature based on the input coolant temperature and at least one speed control setting of the blowers.

20. The system according to claim 19, wherein the controller is further configured to:
control the coolant supply valve to direct the coolant to the engine in response to the engine coolant temperature exceeding the heat exchanger output temperature.
